(19) United States
(12) Patent Application Publication
(10) Pub. No.: US 2025/0028929 A1
(43) Pub. Date: Jan. 23, 2025

(54) METHODS, SYSTEMS, AND COMPUTER READABLE MEDIA FOR TRAINING A MACHINE LEARNING (ML) MODEL USING FUZZ TEST DATA

(71) Applicant: Keysight Technologies, Inc., Santa Rosa, CA (US)

(72) Inventors: Razvan Ionut Stan, Agoura Hills, CA (US); Abhijit Lahiri, Oak Park, CA (US); Peter J. Marsico, Chapel Hill, NC (US)

(21) Appl. No.: 18/224,874

(22) Filed: Jul. 21, 2023

(51) Int. Cl. G06N 3/043; G06N 3/08

(52) U.S. Cl. CPC G06N 3/043; G06N 3/08

(57) ABSTRACT

One example method for training a machine learning model using fuzz test data comprises: at a test system: performing, using test configuration information, a plurality of fuzz testing sessions involving one or more systems under test (SUT); obtaining fuzz test data from one or more sources, wherein the fuzz test data includes test traffic data and SUT performance data associated with the plurality of fuzz testing sessions; training, using the fuzz test data and one or more machine learning algorithms, a machine learning model for receiving as input traffic data involving a respective SUT and SUT performance data and providing as output a stress state value indicating the likelihood of the respective SUT crashing or failing; and storing, in a machine learning model data store, the trained machine learning model for subsequent use by the test system or a SUT analyzer.

### TECHNICAL FIELD

The subject matter described herein relates to testing network elements. More specifically, the subject matter relates to methods, systems, and computer readable media for training a machine learning (ML) model using fuzz test data.

### BACKGROUND

When testing computing and/or networking equipment, it is important to make sure that testing mimics real world scenarios and conditions. For example, when testing a router, a switch, or server, it may be necessary to generate test traffic similar to real traffic including valid and invalid traffic. Fuzz testing or fuzzing is a testing technique that involves providing invalid, unexpected, and/or random data to one or more system(s) under test (SUT) or software therein. During testing, the SUT may be monitored to identify issues or problems associated with the fuzzed data. For example, a testing platform may send invalid, unexpected, and/or malformed packets to a SUT and may monitor the SUT for problems, such as crashes, failing built-in code assertions, or other unwanted behavior.

Conventional testing platforms have issues performing, managing, and/or analyzing fuzz testing. For example, a conventional testing platform may have difficulty continuing fuzz testing when a SUT experiences problems, may be unable to determine if and when fuzzed data actually caused the SUT to experience problems, and/or may be unable to determine how close the SUT came to crashing, especially if the test result is binary, e.g., pass/fail or no crash/crash.

### SUMMARY

Methods, systems, and computer readable media for training a machine learning (ML) model using fuzz test data are disclosed. One example method occurs at a test system. The method comprises: performing, using test configuration information, a plurality of fuzz testing sessions involving one or more systems under test (SUT), wherein at least some of the plurality of fuzz testing sessions include different test traffic parameters and/or SUT configurations than at least one of the plurality of fuzz testing sessions; obtaining fuzz test data from one or more sources, wherein the fuzz test data includes test traffic data and SUT performance data associated with the plurality of fuzz testing sessions; training, using the fuzz test data and one or more ML algorithms, an ML model for receiving as input traffic data associated with test traffic or live traffic involving a respective SUT and SUT performance data associated with the test traffic or live traffic and providing as output a stress state value indicating the likelihood of the respective SUT crashing or failing; and storing, in an ML model data store, the trained ML model for subsequent use by the test system or a SUT analyzer.

According to one example system for training an ML model using fuzz test data, the test system comprises a memory, at least one processor, and a test system implemented using the memory and the at least one processor. The test system is configured for: performing, using test configuration information, a plurality of fuzz testing sessions involving one or more systems under test (SUT), wherein at least some of the plurality of fuzz testing sessions include different test traffic parameters and/or SUT configurations than at least one of the plurality of fuzz testing sessions; obtaining fuzz test data from one or more sources, wherein the fuzz test data includes test traffic data and SUT performance data associated with the plurality of fuzz testing sessions; training, using the fuzz test data and one or more ML algorithms, an ML model for receiving as input traffic data associated with test traffic or live traffic involving a respective SUT and SUT performance data associated with the test traffic or live traffic and providing as output a stress state value indicating the likelihood of the respective SUT crashing or failing; and storing, in an ML model data store, the trained ML model for subsequent use by the test system or a SUT analyzer.

The subject matter described herein may be implemented in software in combination with hardware and/or firmware. For example, the subject matter described herein may be implemented in software executed by a processor (e.g., a hardware-based processor). In one example implementation, the subject matter described herein may be implemented using a non-transitory computer readable medium having stored thereon computer executable instructions that when executed by the processor of a computer control the computer to perform steps. Example computer readable media suitable for implementing the subject matter described herein include non-transitory devices, such as disk memory devices, chip memory devices, programmable logic devices, such as field programmable gate arrays, and application specific integrated circuits. In addition, a computer readable medium that implements the subject matter described herein may be located on a single device or computing platform or may be distributed across multiple devices or computing platforms.

As used herein, the term “node” refers to at least one physical computing platform including one or more processors and memory.

As used herein, the term “system(s) under test” or “SUT” refers to a system (e.g., a network or group of devices or node) or a device or node that is being tested or was tested (e.g., by a test system) or that is being analyzed or was analyzed (e.g., monitored by a monitoring system).

As used herein, the terms “function” and “module” refer to software in combination with hardware and/or firmware for implementing features described herein. In some embodiments, a module may include a field-programmable gate array (FPGA), an application-specific integrated circuit (ASIC), a programmable ASIC, a neural network processing unit, or a processor.

### BRIEF DESCRIPTION OF THE DRAWINGS

The subject matter described herein will now be explained with reference to the accompanying drawings of which:

FIG. 1 is a diagram illustrating an example test environment for perform fuzz testing;

FIG. 2 is a diagram illustrating an example test message comprising fuzzed data;

FIG. 3 is a diagram illustrating an example machine learning (ML) model generator;

FIG. 4 is a diagram illustrating a test system using a trained ML model for determining a stress state value during a test session;

FIG. 5 is a diagram illustrating a monitoring system using a trained ML model for determining a stress state value during a monitoring session;

FIG. 6 is a diagram illustrating example model metadata usable for selecting a trained ML model; and

FIG. 7 is a block diagram illustrating an example process for training an ML model using fuzz test data.

### DETAILED DESCRIPTION

The subject matter described herein relates to methods, systems, and computer readable media for training a machine learning (ML) model using fuzz test data. Network nodes, like routers and switchers, require testing for various reasons including quality assurance. One type of testing includes fuzz testing which can test how resilient or tolerant a network node or group of nodes are to receiving and potentially handling invalid, unexpected, and/or random data, e.g., relative to a group of expected or supported protocols. During testing, the SUT may be monitored to identify issues or problems associated with the fuzzed data. For example, a testing platform may send invalid, unexpected, and/or malformed packets to a SUT and may monitor the SUT for problems, such as crashes, failing built-in code assertions, CPU utilization, memory utilization, packet or message queue depths, or other unwanted behavior.

While a test system may be capable of detecting some issues or SUT misbehavior, e.g., when a SUT crashes and stops responding to the test system, sometimes the test system may be unable to determine how close a SUT was to failing or crashing. In other words, a test operator may perform a number of fuzz test sessions and may receive a no crash/crash or pass/fail score after each test session is completed, but a binary score may not indicate to what extent a fuzz test session affected a SUT's performance. For example, to determine whether a SUT was on the edge of a failure state (e.g., almost “failed”) or whether the SUT easily “passed” a given fuzz test session, a test operator may be required to manually review test logs and make a subjective determination.

In accordance with some aspects of the subject matter described herein, techniques, methods, equipment, systems, and/or mechanisms are disclosed for training a machine learning (ML) model using fuzz test data. For example, a test system may execute various fuzz test sessions involving a SUT for collecting and generating a training dataset for training an ML model. In this example, the test system may vary test traffic rates, transactions per second, new connections per second, and/or other test settings or parameters in the fuzz test sessions when generating a training dataset. In some examples, a test system or other system in accordance with aspects described herein may be configured for obtaining fuzz test data from one or more sources, where the fuzz test data includes test traffic data and SUT performance data (e.g., SUT performance information and/or metrics (SPIM) data) associated with the plurality of fuzz testing sessions; training, using the fuzz test data and one or more ML algorithms (e.g., a recurrent neural network (RNN), a convolutional neural network (CNN), or a feedforward neural network (FNN)), a machine learning model for receiving, as input, traffic data involving a respective SUT and SUT performance data and providing, as output, a stress state value indicating the likelihood of a SUT crashing or failing; and storing, in an ML model data store, the trained machine learning model for subsequent use.

In accordance with some aspects of the subject matter described herein, techniques, methods, equipment, systems, and/or mechanisms are disclosed for using a trained ML model for determining a stress state value (e.g., a stress level) associated with a SUT (e.g., a system being tested, monitored, or analyzed). For example, an analyzer (e.g., of a test system or a monitoring system) may utilize a trained ML model to assist users with interpreting SUT test results, e.g., by estimating a stress level of a SUT in an “off-line” or a post-test session mode. In another example, an analyzer may utilize a trained ML model to determine or estimate real time or near real time stress levels of a SUT (e.g., during a test session or a monitoring session).

Reference will now be made in detail to exemplary embodiments of the subject matter described herein, examples of which are illustrated in the accompanying drawings. Wherever possible, the same reference numbers will be used throughout the drawings to refer to the same or like parts.

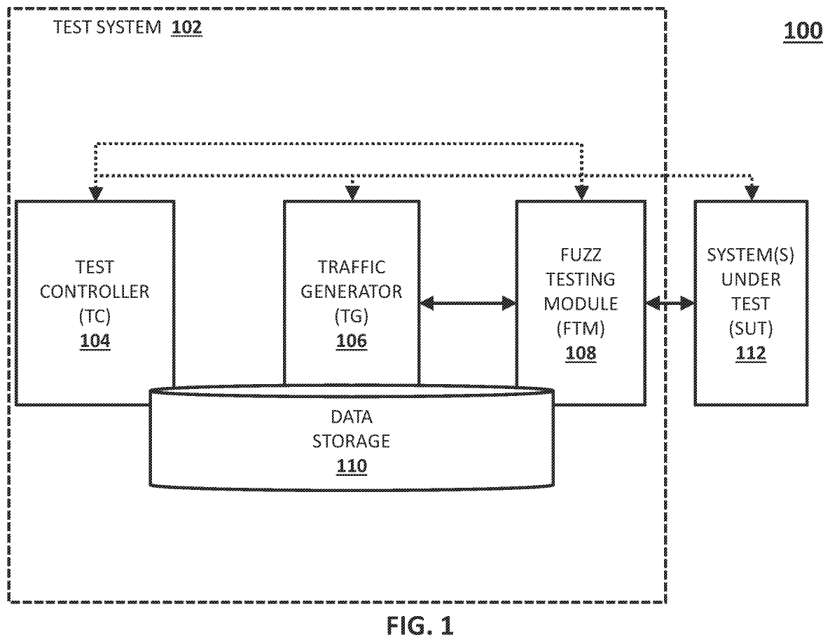

FIG. 1 is a diagram illustrating an example test environment 100 for performing fuzz testing. Referring to FIG. 1, test environment 100 may include test system 102 and one or more device(s) and/or system(s) under test (SUT) 112. Test system 102 may represent any suitable entity or entities (e.g., one or more computing platforms, nodes, or devices) associated with testing SUT 112 (e.g., one or more networks or devices). For example, test system 102 may generate and send traffic to SUT 112, receive traffic from SUT 112, and analyze one or more performance aspects associated with SUT 112.

In some embodiments, test system 102 may be a stand-alone tool, a testing device, or software executing on one or more processor(s). In some embodiments, test system 102 may be a single device or node or may be distributed across multiple devices or nodes. In some embodiments, test system 102 may include one or more modules for performing various test related functions. For example, test system 102 may include an emulation module for emulating one or more nodes or devices that communicates with SUT 112.

In some embodiments, test system 102 may include a test controller (TC) 104, a traffic generator (TG) 106, a fuzz testing module (FTM) 108, and a data storage 110. TC 104 may be any suitable entity or entities (e.g., software executing on a processor, an application-specific integrated circuit (ASIC), a field-programmable gate array (FPGA), or a combination of software, an ASIC, or an FPGA) for performing one or more aspects associated with instructing or controlling a TC 106 and/or for facilitating configuration of various aspects of test system 102. In some embodiments, TC 104 may be implemented using processor(s) (e.g., a physical processor, a general purpose microprocessor, a single-core processor, a multi-core processor, an FPGA, and/or an ASIC for executing software and/or logic) and/or memory for storing data, logic, software, or other information.

In some embodiments, TC 104 may include one or more communications interfaces, e.g., one or more network interface cards (NICs), for interacting with users, modules, and/or nodes. For example, TC 104 may use one or more communications interfaces for receiving or sending various messages. In this example, some of the communications interfaces support automation, e.g., via one or more programming languages (e.g., python, PHP, etc.), a representation state transfer (REST) API, a command line, and/or a web-based GUI.

In some embodiments, TC 104 may include or provide a communications interface for allowing a user or another entity (e.g., an automated system or a device or system controlled or controllable by a human user) for selecting and/or configuring various aspects associated with testing SUT 112 and/or generating testing related metrics. For example, various user interfaces (e.g., an application user interface (API) and a graphical user interface (GUI)) may be provided for receiving user input or test configuration information, such as tests to be performed, types of metrics or statistics to be generated, a number of test messages per port or stream to be generated, and/or other settings.

In some embodiments, TC 104 may include one or more communications interfaces for interacting with test related entities, e.g., a test operator, TG 106, FTM 108, or other entities involved in testing SUT 112. For example, TC 104 may utilize a configuration API (e.g., a REST-based API) for sending configuration information (e.g., a traffic profile) to TG 106 for generating test traffic and may also use this API or a similar API for sending configuration information (e.g., a fuzzing profile) to FTM 108 for fuzzing at least some of the test traffic. Example TG configuration information may indicate what type or amount of test traffic is to be generated, what content to include (e.g., parameter values, sequence numbers, predetermined responses, etc.), speed or bandwidth usage associated with different test flows, etc. Example FTM configuration information may indicate what type or amount of test traffic to fuzz, what content to fuzz (e.g., parameter values, sequence numbers, predetermined responses, etc.), etc.

TG 106 may be any suitable entity or entities (e.g., software executing on a processor, an ASIC, an FPGA, or a combination of software, an ASIC, or an FPGA) for performing one or more aspects associated with generating or synthesizing test sessions, test cases, or related test packets. For example, TG 106 may receive configuration information (e.g., a test traffic profile based on one or more test traffic templates, port settings, network emulation settings, etc.) from TC 104. In this example, TG 106 may use the received configuration information or related commands to generate test traffic associated with a test session or related scenario.

FTM 108 may be any suitable entity or entities (e.g., software executing on a processor, an ASIC, an FPGA, or a combination of software, an ASIC, or an FPGA) for performing one or more aspects associated with generating or causing fuzzed traffic or packets. For example, FTM 108 may receive configuration information (e.g., a fuzzing profile based on one or more test traffic templates, port settings, network emulation settings, etc.) from TC 104. In some embodiments, FTM 108 may use the received configuration information or related commands to intercept and modify at least some portion of the test traffic (e.g., by fuzzing or corrupting a header parameter value or a payload of one or more packets) that traverses FTM 108 before reaching SUT 112. For example, FTM 108 may include functionality for intercepting and changing various test messages to include fuzzed data (e.g., random, invalid, or unexpected data for testing SUT 112, e.g., parameters and/or user data). In another example, FTM 108 may include functionality for generating test messages that include fuzzed data. In some examples, fuzzed test messages may include packets or frames that conform to one or more protocols and/or may appear normal or valid (e.g., to a network protocol analyzer). After sending or forwarding test messages containing fuzzed data, FTM 108 may be configured to monitor and interact with SUT 112 and/or may determine whether SUT 112 experiences any issues associated with the test messages.

In some embodiments, FTM 108 may be a stand-alone or distinct virtual or physical node or may be integrated with another entity (e.g., TG 106 or TC 104). For example, in some environments, FTM 108 may be a distinct device that sits in-line between TG 106 and SUT 112 and may intercept and modify test traffic from TG 106 destined for SUT 112. In another example, FTM 108 and TG 106 may be co-located on the same platform and, as such, test traffic may be fuzzed at generation or prior to leaving the platform.

In some embodiments, types or configurations of fuzz processing may be referred to or implemented using fuzzing profiles. For example, a fuzzing profile may include instructions for FTM 108 indicating how and/or when some traffic is to be modified or fuzzed by FTM 108 prior to reaching SUT 112.

In some embodiments, fuzzed data may be generated and/or included in test messages for testing various aspects of SUT 112. For example, fuzzed data may be utilized to determine whether SUT 112 has correctly implemented a particular network standard or protocol. In this example, FTM 108 may attempt to generate parameter values and/or user data that is random, invalid, atypical, or unexpected data. In another example, fuzzed data may be utilized to determine whether SUT 112 includes security flaws or bugs associated with communications. In this example, FTM 108 may attempt to generate parameter values and/or user data that cause common problems, such as buffer overflow issues, processing throughput reductions, response time delay or latency increases, system stability degradation, system key-resource utilization increases or system crashes. Such problems may be identified by monitoring some or all of the above indicators, or other DUT/SUT-specific key performance indicators. In some embodiments, test system 102 or a related entity may be adapted to monitor congestion control signaling messages generated by SUT 112 (e.g., a network node or device) and use the associated congestion information to infer a health status of SUT 112. In some embodiments, test system 102 or a related entity may be adapted to monitor in-band telemetry information that is generated or transmitted by SUT 112 (e.g., a network of devices) and use the associated congestion information to infer a health status of SUT 112.

In some embodiments, TC 104, TG 106, FTM 108, and/or other entities of test system 102 may include functionality for accessing data storage 110. Data storage 110 may be any suitable entity or entities (e.g., a storage device, a memory, a non-transitory computer readable medium, or a storage system) for maintaining or storing information related to testing. For example, data storage 110 may store various fuzz testing profiles, traffic profiles, historical fuzz test data (e.g., usable for training an ML model or for analysis by a test operator), various trained ML models with metadata, network or test topology data, SUT information, test results, or other information. In some embodiments, data storage 110 may be located at one node or platform or distributed across multiple platforms or devices.

SUT 112 may be any suitable entity or entities (e.g., devices, systems, or platforms) for communicating with or being analyzed by test system 102, a monitoring system, or related entities. In some embodiments, SUT 112 may be configured for receiving, processing, forwarding, and/or sending test traffic, non-test traffic, or other data. For example, SUT 112 may refer to device or platform that is involved in a fuzz test session. In another example, SUT 112 may refer to a system or device (e.g., in a live or production network) that is being monitored by a monitoring system, e.g., traffic to or from the system or device is monitored by a network probe.

In some embodiments, SUT 112 may include a network router, a network switch, a network device, a server, a network controller, or a network comprising various devices or entities. For example, SUT 112 may include one or more systems and/or computing platforms, e.g., a data center or a group of servers and/or switches connected via a network. In another example, SUT 112 may include one or more networks or related components, e.g., a converged Ethernet network, a voice over internet protocol (VoIP) network, an access network, a core network, or the Internet.

In some embodiments, reporting agents, monitoring agents, test agents, or other agents associated with test system 102 may be deployed (e.g., by TC 104) to various locations, devices, or platforms in test environment 100. For example, prior to starting a test session, a test operator may install test software (e.g., a reporting agent) on SUT 112. In this example, the SUT-based reporting agent may receive configuration instructions from TC 104 and may be capable of receiving commands and requests from TC 104 or other test related entities. In some embodiments, a SUT-based reporting agent may be capable of accessing, deriving, or determining SUT performance data, e.g., state information, load status, available buffer space, memory utilization, processor utilization, processor queue depth, message throughput rate, failures, latency, issues, and/or other information for determining how SUT is currently behaving or performing.

In some embodiments, a reporting or monitoring agent may include functionality for communicating with (e.g., periodically polling) an administrative subsystem of SUT 112 to obtain SUT performance data, e.g., via a SUT supported API, a query and response mechanism, or a subscribe and publish mechanism. For example, an administrative subsystem of SUT 112 may maintain a number of metrics or other relevant data and, by using a SUT supported API or other appropriate communication technique, a remote reporting agent or monitoring agent may request and receive SUT performance data, e.g., without additional software being installed on SUT 112.

In some embodiments, SUT performance data may include performance metrics that are measured, observed, collected via a software probe or agent (e.g., u-probe, k-probe, BPF, eBPF, etc.) installed and running on SUT 112 or a hardware platform that is hosting SUT 112. For example, a SUT-based agent may be synchronized with SUT 112 and/or test system 102, such that data collected via the agent is timestamped and correlated with traffic data (e.g., fuzzed test traffic transmitted to SUT 112 from test system 102). In this example, the correlated traffic data and SUT performance data may be usable for training an ML model for determining a stress state value (e.g., a stress level) associated with SUT 112.

Example SUT performance data may include information or metrics indicating whether new protocol sessions (e.g., border gateway protocol (BGP), hypertext transfer protocol (HTTP), network time protocol (NTP), or file transfer protocol (FTP) sessions) are take longer to initialize or start; whether API responses are slower than expected or slow than they were initially or if API responses are starting to fail; whether a sudden or unexpected packet drops, memory, latency, buffer utilization or processor utilization increase has occurred; whether a file handle anomaly, a dmesg (e.g., a kernel ring buffer message) anomaly, a logging anomaly, or a telemetry anomaly has occurred, whether an unexpected change (e.g., a corruption, excesses writes or reads, etc.) in a routing table has occurred; whether one or more processes or services are experiencing issues or experiencing unexpected usage pattern changes; or whether hardware issues have occurred (e.g., a change or failure of a fan or overheating).

In some embodiments, TC 104, TG 106, or FTM 108 may include a reporting or monitoring agent or similar functionality for collecting, obtaining, or reporting traffic data. For example, a TG-based agent or an FTM-based agent may be synchronized with SUT 112 and/or test system 102, such that data collected via the agent is timestamped and correlated with contemporaneous SUT performance data. In this example, the correlated traffic data and SUT performance data may be usable for training an ML model for determining a stress state value (e.g., a stress level) associated with SUT 112.

Example traffic data may include copies of test packets, test packet content data (e.g., routing label field values, protocol header field values, payload content values, in-band telemetry data, and/or metadata), test settings, and metrics associated with test traffic or monitored traffic, e.g., total traffic rate, fuzzed traffic rate, a percentage indicating the amount of fuzzed traffic to total traffic, etc.

It will be appreciated that FIG. 1 is for illustrative purposes and that various nodes and/or modules, locations, and/or functionality described above in relation to FIG. 1 may be changed, altered, added, or removed. For example, TG 106 and FTM 108 or aspects thereof may be combined or integrated into a single platform, device, or entity.

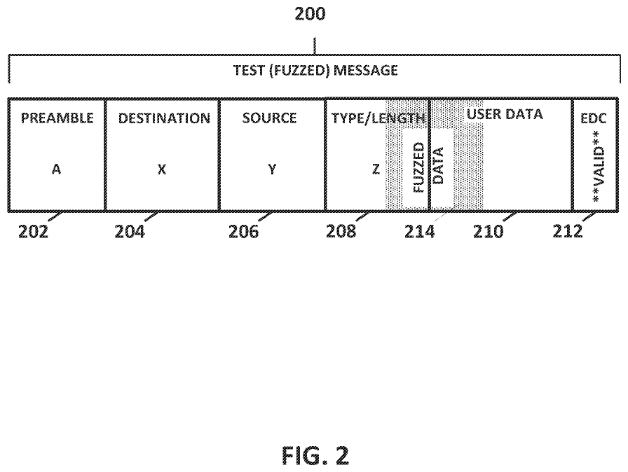

FIG. 2 is a diagram illustrating an example test message 200 comprising fuzzed data. Test message 200 may represent any message (e.g., a PDU, a frame, or a packet) usable for testing SUT 112. Test message 200 may include fuzzed data and may be generated and sent to SUT 112 via FTM 108 and/or a related port. In some embodiments, test message 200 may conform to a specific protocol and/or may otherwise appear normal or valid. In some embodiments, test message 200 may not conform to a specific protocol and/or may otherwise appear abnormal or invalid.

Referring to FIG. 2, test message 200 may represent an Ethernet packet including a preamble 202, a destination address 204, a source address 206, a type or length parameter (TLP) value 208, user data 210, and/or an error detection code (EDC) 212. Preamble 202 may represent a seven octet (e.g., seven bytes) data portion indicating the start of an Ethernet packet. Destination address 204 may represent a six octet data portion indicating a media access control (MAC) address for a destination node. Source address 206 may represent a six octet data portion indicating a MAC address for a source node. TLP value 208 may represent a two octet data portion and may indicate a protocol encapsulated in the payload portion (e.g., user data 210) or may indicate the size of the payload in octets for the payload portion. User data 210 may represent a data portion (e.g., generally between 46 and 1500 octets in size) including payload information usable for various purposes. EDC 212 may represent a four octet data portion (e.g., a cyclic redundancy check (CRC)) usable for detecting data corruption associated with test message 200.

In some embodiments, test message 200 may include fuzzed data 214. Fuzzed data 214 may represent a data portion of various octets and may include any information for testing SUT 112 or related components or software therein. For example, fuzzed data 214 may include header information or portions therein, e.g., TLP value 208. In another example, fuzzed data 214 may include user data 210 or a portion therein.

In some embodiments, test message 200 may include indication information usable for identifying test message 200 as a test message and/or as containing fuzzed data 214. For example, a “fuzzed packet” signature or a marker may be added or included in a header portion or payload portion of test message 200 in such a way that test message 200 still conforms to a relevant protocol. In this example, the signature or marker may indicate (e.g., to test or monitoring system, a user, or another entity) that test message 200 includes fuzzed data 214. In some embodiments, indication information may also include state information or related information about fuzz testing. For example, the state information may include progress information about a current test being performed.

It will be appreciated that test message 200 is for illustrative purposes and that different and/or additional information may be included in test message 200.

In some embodiments, test system 102 (e.g., with appropriate monitoring and/or reporting agents) may monitor and collect SUT performance data along with test traffic data during fuzz test sessions. In such embodiments, this collected data can be used (e.g., by a test operator or another entity) to detect how a SUT responds to fuzz testing or portions thereof. For example, collected information may indicate that new protocol sessions are taking longer to initialize, that a protocol daemon running on a SUT is crashing, that the SUT is experiencing unexpected increases in memory or processor utilization, that the SUT's response latency is increasing, or that unexpected changes in different SUT data stores are occurring. In this example, collected information from multiple fuzz test sessions can be used to trained an ML model to identify patterns in stress levels (e.g., patterns that indicating when SUT 112 is becoming more stressed and closer to failing) and to generate a stress state value indicating how close or near the SUT is to failing or crashing.

In some embodiments, test system 102 may include functionality for performing multiple fuzz test sessions for collecting fuzz test data. Example fuzz test data may include traffic data (e.g., packet content or a sample thereof, traffic metrics, etc.) and SUT performance data (e.g., information or metrics indicating that the SUT is experiencing issues or performance changes) for each of the test sessions. In some embodiments, the fuzz test data may also be correlated (e.g., using timestamps) and may also include test operator ratings (outcomes) usable in supervised learning techniques.

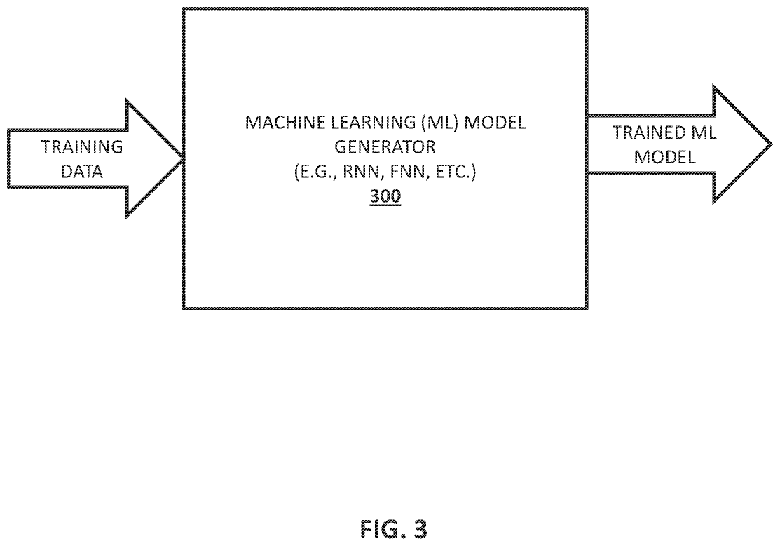

FIG. 3 is a diagram illustrating an example ML model generator 300. In some embodiments, ML model generator 300 may be any suitable entity or entities (e.g., software executing on a processor, an ASIC, an FPGA, or a combination of software, an ASIC, or an FPGA) for generating a trained ML model. For example, ML model generator 300 may include one or more ML algorithms and one or more training techniques for training the one or more ML algorithms. In this example, training an ML algorithm may include teaching an ML algorithm to learn stress state patterns and relationships associated with SUT 112 using training data from data collected or derived from a plurality of fuzz test sessions.

In some embodiments, ML model generator 300 may utilize a training process that includes selecting an architecture for an ML model (e.g., an RNN or an FNN), obtaining a dataset (e.g., a dataset comprising traffic data and SUT performance data from multiple fuzz test sessions along with corresponding operator-defined labels (e.g., targets, outcomes, or ground truths) representing stress level values), initializing the ML model (e.g., with default parameter values), training or optimizing the ML model, and verifying or finalizing the trained ML model.

In some embodiments, selecting an ML architecture may involve selecting a type of artificial neural network (ANN), such as an RNN, a CNN, an FNN, etc. In such embodiments, ML architecture selection may be based on an operator's preferences, configuration or model of SUT 112, type(s) of traffic being processed at SUT 112, and/or other factors. For example, a RNN may be selected when SUT 112 is handling mostly interconnected packets (e.g., packets in VoIP or SIP sessions) because RNNs represent a class of artificial neural network where connections between nodes form a directed graph along a sequence. In this example, an RNN can exhibit temporal dynamic behavior for a time sequence and, unlike FNNs, the RNN can use their internal state (memory) to process sequences of inputs. In another example, an FNN may be selected when SUT 112 is expected to handle mostly independent messages.

In some embodiments, obtaining a dataset may include collecting traffic data from test system 102 (or agents thereof) and SUT performance data from SUT 112 (or agents thereof). In some embodiments, a dataset used in training may include different types of data or data in different forms depending on the ML architecture, the relevant features (e.g., inputs) used, and corresponding labels (outputs) expected. For example, a dataset for training an RNN to determine a SUT stress state value may include data from sequential test packets along with SUT performance data at various times during testing. In this example, both traffic data and SUT performance data may be timestamped (e.g., by an accurate clock) and correlated. In another example, a dataset for training an FNN to determine a SUT stress state value may include traffic rate metrics and fuzzed data metrics along with contemporaneous SUT performance metrics.

In some embodiments, a dataset or data therein may undergo various preprocessing steps, including cleaning, normalization, or feature engineering, to ensure data quality and suitability for effective model training. In some embodiments, a dataset may also be divided into subsets for different purposes, e.g., a training dataset, a validation dataset, and optionally a final test dataset. For example, a training dataset may be utilized to train the ML model, while a validation dataset may facilitate optimization (e.g., ongoing evaluation and fine-tuning during the training process), and a final test dataset may be used for measuring a final model's performance (e.g., since the final dataset is not used in training or optimization).

In some embodiments, an ML model may be initialized with random or predetermined parameter values (e.g., adjustable internal settings) and then, during the training process, one or more of these parameter values will be adjusted for facilitating or approximating the stress state patterns and/or related relationships expressed or implied in the training dataset.

In some embodiments, e.g., as part of training the ML model, training samples (e.g., data collected from a single fuzz test session, observation, or a particular point in time) may be iteratively processed by feeding input data into the model, receiving predictions regarding a stress state or stress level, and then comparing the predictions to operator-provided labels (e.g., ground truths or outcomes), e.g., by generating a performance metric (e.g., a loss or cost function). In some embodiments, the input data for a given training sample may be a fixed-length binary vector and may represent various features or inputs that the model uses.

In some embodiments, features or inputs used by an ML model can vary depending on a number of factors, e.g., an ML architecture, type of SUT 112, type of traffic, etc. In some embodiments, features or inputs used by an ML model may include Boolean or non-Boolean values expressed as bits in one or more initial binary vector(s) that are inputted into an ML model. In some embodiments, features or inputs used by an ML model may include Boolean or non-Boolean values that are converted into individual, discrete vectors and are then inputted into an ML model.

Example SUT performance data features or inputs may indicate whether new protocol sessions are take longer to initialize or start; whether API responses are slower than expected or slow than they were initially or if API responses are starting to fail; whether a sudden or unexpected packet drops, memory, latency, buffer utilization or processor utilization increase has occurred; whether a file handle anomaly, a dmesg (e.g., a kernel ring buffer message) anomaly, a logging anomaly, or a telemetry anomaly has occurred, whether an unexpected change (e.g., a corruption, excesses writes or reads, etc.) in a routing table has occurred; whether one or more processes or services are experiencing issues or experiencing unexpected usage pattern changes; or whether hardware issues have occurred (e.g., a change or failure of a fan or overheating). Additional example SUT performance data features or inputs may indicate various metrics associated with SUT performance or health including, for example, a dropped packet rate, a total bandwidth received or processed, a buffer or memory amount remaining, or a buffer or memory amount used, a total bandwidth of fuzzed or other select type of traffic, or a percentage of a fuzzed or select traffic to total traffic processed by SUT 112.

Example traffic data features or inputs may include traffic characteristics (e.g., packet content locations or packet header parameters being fuzzed), the number of fuzzed or test packets generated or observed, rate of fuzzed packets generated or sent toward SUT 112, a protocol or session makeup of traffic generated or observed, or environmental or topology information related to traffic generated or observed.

In some embodiments, a training loop using samples from a training dataset may be repeated for multiple iterations or until the model's performance on the validation dataset reaches a satisfactory level (e.g., loss function value is at or below a threshold value). In some embodiments, the amount of training or optimization (e.g., number of iterations and other training parameters) may vary, e.g., depending on the complexity of the environment and dataset characteristics.

In some embodiments, an optimization algorithm (e.g., gradient descent) may be performed during the training of an ML model to adjust its parameters and minimize a predefined loss or error function. For example, an optimization algorithm may involve performing forward propagation to generate predictions, calculating the loss by comparing predicted and target values, backpropagation to compute gradients of the loss with respect to the parameters used by the model, and parameter updates based on the gradients generated by the optimization algorithm.

In some embodiments, an optimization algorithm may be an iterative process (e.g., running after one or more training sample iteration) and may be usable for finding optimal parameter values that minimize the loss and improve the model's performance on the training data, ultimately enabling accurate predictions or desired outputs.

In some embodiments, techniques like regularization and validation may be used alongside optimization to prevent overfitting and ensure the model generalizes well to new data. For example, after some training or optimization using a training dataset, a validation process may be executed. The validation process may input data from a validation dataset (e.g., acting as a proxy for unseen or real data) into an ML model to generate predictions and those predictions may be compared to known labels using a loss or cost function. In this example, the validation process and/or the validation dataset may be useful in monitoring the ML model's progress and for detecting signs of overfitting or underfitting. By evaluating the model on the validation dataset, adjustments can be made to prevent overfitting, such as tuning hyperparameters or applying regularization techniques.

In some embodiments, e.g., as a final step and once training and optimization is complete, a final validation process may be executed using a final test dataset. For example, a final test dataset may include data that was never used to trained an ML model and, as such, the trained ML model's performance may be assessed using this data, thereby providing an unbiased estimate of its generalization and accuracy.

In some embodiments, fuzz test data (e.g., traffic data and SUT performance data from a series of fuzz test sessions or other test sessions) may be used in one or more training methodologies (e.g., a conventional artificial neural network (ANN) methodology) to train an ANN, e.g., an FNN, RNN, etc. For example, when training an FNN, fuzz test data may include little to no time series based traffic data or the training process may not use the time series based traffic data for predicting stress state patterns. In another example, when training an RNN, fuzz test data may include substantial time series based traffic data and the training process may not use the time series based traffic data for predicting stress state patterns.

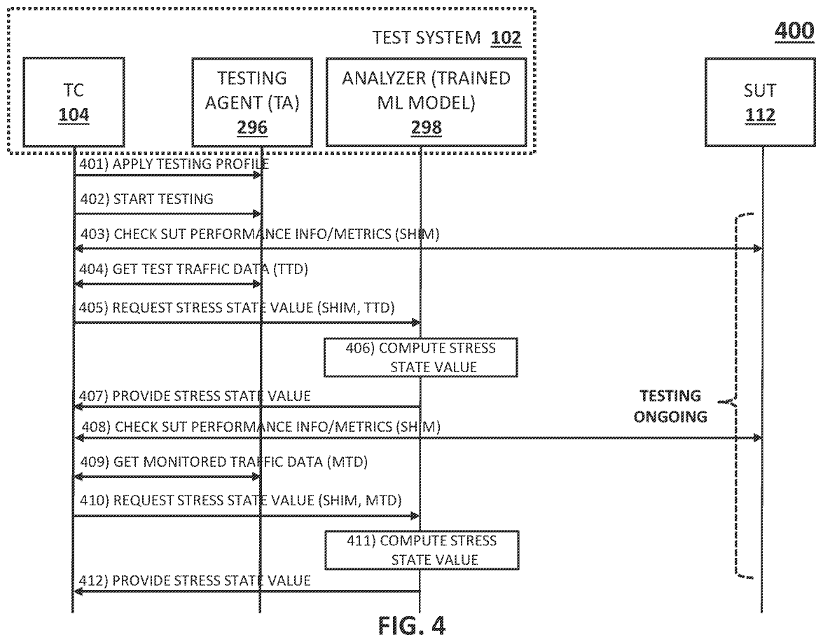

In some embodiments, a trained ANN model may be used to determine or estimate a SUT stress state value (e.g., a stress level) during or after a subsequent traditional test or fuzz test, e.g., as described below with regard to FIG. 4. In some embodiments, a trained ANN model may be used to determine or estimate a network element stress state value (e.g., a stress level) in a live network setting (e.g., as part of a network monitoring system), etc.), e.g., as described below with regard to FIG. 4.

In some embodiments when training a trained RNN-based model, inputs may typically be represented as sequences, e.g., where each element corresponds to a packet or a specific piece of data within the packet. In such embodiments, the RNN-based model may process these inputs sequentially, one element at a time, while maintaining an internal hidden state that captures context and dependencies across the sequence. This hidden state is updated at each step, allowing the RNN-based model to retain memory of previously seen packets. By considering the sequence of packets and associated SUT performance metrics (e.g., latency, throughput, processing speed, processor or device temperature, error rates, in-band telemetry data, etc.), the RNN-based model can learn patterns and trends that precede SUT failures. With this knowledge, the RNN-based model becomes capable of predicting potential device failures based on sequence related input, e.g., a sequence of packets or packet data and their associated effect on SUT performance. After training, the RNN-based model can make predictions on new input data, providing valuable insights into the likelihood of SUT failure and enabling proactive maintenance or mitigation strategies. For example, a trained RNN-based model may generate predictions or decisions based on input data, e.g., predicting or estimating a stress level or stress state value associated with SUT 112.

In some embodiments when training a FNN-based model, inputs may typically be represented as a set of features derived from the packets, and SUT performance metrics may be used as labels or target variables. In such embodiments, the FNN-based model may processes input features through its layers in a forward direction, without any feedback loops. By leveraging hidden layers and activation functions, the FNN-based model may learn or capture complex relationships and patterns between the input data and the likelihood of device failure. For example, during the training process, the FNN-based model may learn to associate specific combinations of input features and performance metrics with the failure of a SUT. Once trained, the FNN-based model can make predictions on new input data, providing valuable insights into the likelihood of SUT failure and enabling proactive maintenance or mitigation strategies. For example, a trained FNN-based model may predictions or decisions based on input data, thereby facilitating tasks like predicting a stress level or stress state value associated with SUT 112.

In some embodiments, output from an ML model may be involve a decimal value between 0-1 and/or may relate to a value or score indicating how close a SUT (e.g., a network device being tested, monitored, or analyzed) is to crashing or failing or the likelihood a SUT will crash or failure. For example, assume a trained ML model outputs a 0 for a certain set of inputs when there is no chance at all of SUT 112 crashing now or in the near term (e.g., within the next 30 seconds), outputs a 0.25 for the set of inputs when there is a 25% chance of SUT 112 crashing now or in the near term, outputs a 0.50 for the set of inputs when there is a 50% chance of SUT 112 crashing now or in the near term, and outputs a 0.99 for the set of inputs when there is a 99% chance of SUT 112 crashing now or in the near term (e.g., with in the next 30 seconds), and so on. In this example, the trained ML model or a related entity (e.g., a reporting function) may covert this decimal value to a stress state value (e.g., using colors, descripting words, “soft” or “fuzzy” stress levels between 0-5 or 1-10, or chance of failure percentages) that is easy for a human to understand.

In some embodiments, a trained ML model may assist with interpreting test results, e.g., by estimating a stress level of SUT 112 in an “off-line” or a post-test session mode. In another example, an analyzer may utilize a trained ML model to determine or estimate real time or near real time stress levels of a SUT (e.g., during a test session or a monitoring session).

In some embodiments, test system 102, ML model generator 300, or another entity may store trained ML models in an ML model data store (e.g., a library or repository implemented in network accessible data storage) and may be accessible by various entities, e.g., network operators, SUT analyzers, test agents, etc. For example, a network operator may generate one or more trained ML models that are designed to infer or estimate stress levels of various types or models of SUTs, e.g., different brands and models of routers, switches, network gateways, or web servers.

It will be appreciated that FIG. 3 is for illustrative purposes and that various functionality described above in relation to FIG. 3 may be changed, altered, added, or removed.

FIG. 4 is a diagram illustrating a scenario 400 involving test system 102 using a trained ML model for determining a stress state value during a test session. In some embodiments, test system 102 may include TC 104 for configuring and controlling a testing agent (TA) 296 and analyzer 298 (e.g., software that analyzes traffic using a trained ML model for indicating a stress state value). In some embodiments, TA 296 may be any suitable entity or entities (e.g., software executing on a processor, an ASIC, an FPGA, or a combination of software, an ASIC, or an FPGA) for performing one or more test related tasks. In some embodiments, TA 296 may include FTM 108, TG 106, and/or some of their capabilities. For example, TA 296 may include software or logic for generating and/or sending test traffic, for fuzzing test traffic or portions thereof, for stopping or pausing a test (e.g., based on preconfigured criteria being met), and/or for collecting or maintaining test state information, test traffic metrics, or other information.

In some embodiments, analyzer 298 may include or utilize a trained ML model to determine a stress level (e.g., a stress state value) associated with SUT 112 (e.g., a system or device involved in fuzz testing). In such embodiments, analyzer 298 may compute a stress level associated with SUT 112 periodically, aperiodically, or on-demand. For example, during a test session, TC 104 may request that a “current” estimated stress level associated with SUT 112 be computed by analyzer 298 multiple times. In another example, TC 104 may request an estimated stress level associated with SUT 112 at or near the end of a test session, e.g., as a final or end score. For example, as depicted in FIG. 4, TC 104 may be configured for polling (e.g., requesting from) SUT 112 (or a related entity) for SUT performance data (e.g., SUT performance or health metrics) and for obtaining test traffic data (e.g., copied packets, metrics related to total traffic rates or percentage of fuzzed test traffic, etc.) during the course of a test session (e.g., from TA 296 at different points in time). In this example, TC 104 may query analyzer 298 (or a trained ML model thereof) for estimated or inferred stress state values using recently obtained data, e.g., as conditions change.

In another example, TA 296 or analyzer 298 may be configured for performing stress state checks at period or predetermined intervals, e.g., every 60 seconds, when a test traffic or fuzzed traffic load reaches a certain threshold values, at a particular time in the day, etc. In this example, TA 398 or analyzer 298 may be capable of requesting or accessing relevant information from appropriate sources, e.g., data stores, SUT 112, TA 398, or various agents or devices. Continuing with this example, TA 398 or analyzer 298 may input the data or a version thereof (e.g., one or more binary vectors representing various features) into an appropriate trained ML model (e.g., software executing on one or more processors) to obtain a predicted or estimated stress state value based on the input.

In some embodiments, e.g., prior to a test session, TC 104 or another entity may select an appropriate trained ML model from an ML model data store (e.g., in data storage 110 or located in an accessible memory or storage device). For example, using a test operator's preferences or settings, TC 104 may identify a trained ML model that most closely matches the test environment or SUT 112.

Referring to FIG. 4, at 401, TC 104 may send or apply a testing profile at or on TA 296. For example, TA 296 may include a TG 106 with FTM 108 or similar functionality. In this example, a testing profile may include configuration information usable for generating test traffic and related fuzzing thereof for a test session.

At 402, TC 104 may instruct TA 296 and/or other entities to start a test session. For example, TC 104 may send a start command to TA 296 via a control plane or a management protocol.

At 403, at some point during a test session, TC 104 may request and receive SUT performance data from SUT 112 or a related entity (e.g., a SUT-based reporting agent). For example, using a SUT supported API, TC 104 may request current (e.g., most recent) SUT metrics or SUT state information from SUT 112 and SUT 112 may respond to the request with the requested information.

At 404, TC 104 may request and receive test traffic data from TA 296 or a related entity (e.g., a TA-based reporting agent). For example, using a supported API, TC 104 may request current (e.g., most recent) traffic metrics or packet copies from TA 296 and TA 296 may respond to the request with the requested information.

At 405, TC 104 may request an estimated or inferred stress state value associated with SUT 112 (e.g., indicating how close to failing or crashing SUT 112 is) from analyzer 298 or a related trained ML model. For example, using a supported API, TC 104 may provide collected SUT performance data and traffic data to analyzer 298 and a trained ML model associated with analyzer 298 may use at least some of this data to generate or compute a stress state value associated with SUT 112.

At 406, analyzer 298 or a related entity (e.g., a trained ML model thereof) may use input (e.g., SUT performance data and test traffic data) obtained from TC 104 or other entities to generate a current estimated or inferred stress state value associated with SUT 112. For example, analyzer 298 may receive data from TC 104 or another entity and generate, using the data, one or more vectors for a trained ML model and the trained ML model may output a stress state value (e.g., a stress level) using the one or more generated vectors and/or other data as input.

At 407, analyzer 298 or a related entity may provide the estimated or inferred stress state value associated with SUT 112 (e.g., indicating how close to failing or crashing SUT 112 is) to TC 104. For example, after determining a stress state value associated with SUT 112, analyzer 298 may provide the stress state value to TC 104, e.g., via a supported API, protocol, or delivery mechanism.

At 408, at a later point in the test session, TC 104 may request and receive SUT performance data from SUT 112 or a related entity (e.g., a SUT-based reporting agent). For example, using a SUT supported API, TC 104 may request current (e.g., most recent) SUT metrics or SUT state information from SUT 112 and SUT 112 may respond to the request with the requested information.

At 409, TC 104 may request and receive test traffic data from TA 296 or a related entity (e.g., a TA-based reporting agent). For example, using a supported API, TC 104 may request current (e.g., most recent) traffic metrics or packet copies from TA 296 and TA 296 may respond to the request with the requested information.

At 410, TC 104 may request an estimated or inferred stress state value associated with SUT 112 (e.g., indicating how close to failing or crashing SUT 112 is) from analyzer 298 or a related trained ML model. For example, using a supported API, TC 104 may provide collected SUT performance data and traffic data to analyzer 298 and a trained ML model associated with analyzer 298 may use at least some of this data to generate or compute a stress state value associated with SUT 112.

At 411, analyzer 298 or a related entity (e.g., a trained ML model thereof) may use input (e.g., SUT performance data and test traffic data) obtained from TC 104 or other entities to generate a current estimated or inferred stress state value associated with SUT 112. For example, analyzer 298 may receive data from TC 104 or another entity and generate, using the data, one or more vectors for a trained ML model and the trained ML model may output a stress state value (e.g., a stress level) using the one or more generated vectors and/or other data as input.

At 412, analyzer 298 or a related entity may provide the estimated or inferred stress state value associated with SUT 112 (e.g., indicating how close to failing or crashing SUT 112 is) to TC 104. For example, after determining a stress state value associated with SUT 112, analyzer 298 may provide the stress state value to TC 104, e.g., via a supported API, protocol, or delivery mechanism.

It will be appreciated that FIG. 4 is for illustrative purposes and that various actions and functionality described above in relation to FIG. 4 may be changed, altered, added, or removed. For example, various functionality in analyzer 298 and TC 104 may be combined into a single entity. In another example, TA 296 may include analyzer 298, a trained ML model, or related functionality. In some examples, analyzer 298 may be configured to periodically or aperiodically obtain traffic data and SUT performance data directly from source(s) and generate a new stress state value using the recently obtained data.

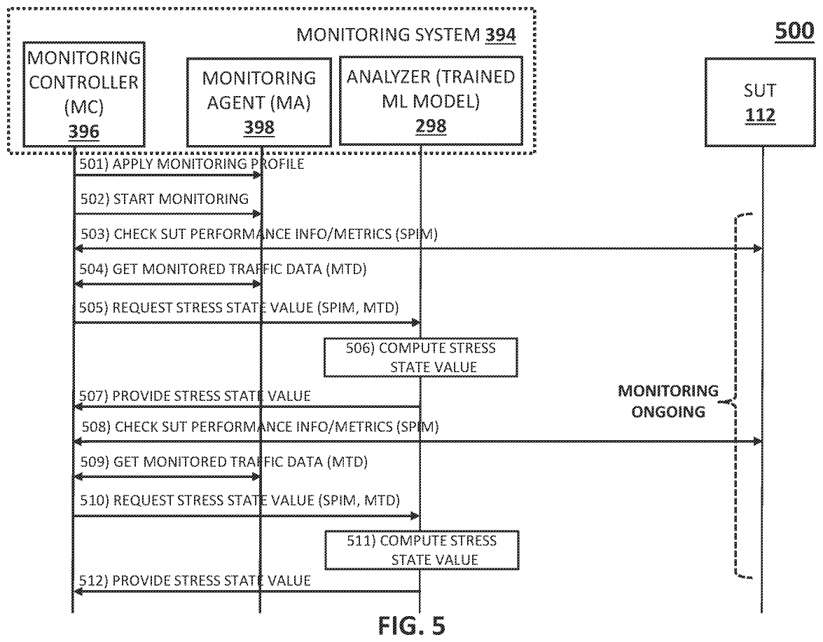

FIG. 5 is a diagram illustrating a scenario 500 involving a monitoring system 394 using a trained ML model for determining a stress state value during a monitoring session. In some embodiments, monitoring system 394 may represent any suitable entity or entities (e.g., one or more computing platforms, nodes, or devices) associated with monitoring SUT 112 (e.g., one or more networks or devices) or related traffic. For example, in live or test network, monitoring system 394 may monitor and/or analyze at least some of the traffic to or from SUT 112.

In some embodiments, monitoring system 394 may include a stand-alone platform and/or software executing on one or more processor(s). In some embodiments, monitoring system 394 may be a single device or node or may be distributed across multiple devices or nodes. In some embodiments, monitoring system 394 may include one or more modules for performing various monitoring functions.

In some embodiments, monitoring system 394 may include a monitoring controller (MC) 396 for configuring and controlling a monitoring agent (MA) 398 (e.g., a network probe or tap) and analyzer 298 (e.g., software that analyzes traffic using a trained ML model for indicating a stress state value). In some embodiments, MA 398 may include a software-based network traffic probe that can be configured to intercept or inspect traffic that matches characteristics indicated by a monitoring profile. In some embodiments, MA 398 may include a hardware-based network traffic probe that can be configured to intercept, copy, or inspect traffic that matches characteristics indicated by a monitoring profile or a hardware-based network traffic probe that can copy traffic and provide the copied traffic to another entity (e.g., software or analyzer 298) for identifying traffic that matches characteristics indicated by a monitoring profile.

In some embodiments, analyzer 298 may include or utilize a trained ML model to determine a stress level (e.g., a stress state value) associated with SUT 112 (e.g., a system being monitored). In such embodiments, analyzer 298 may compute a stress level associated with SUT 112 periodically, aperiodically, or on-demand. For example, during a monitoring session, MC 396 may request that a “current” estimated stress level associated with SUT 112 be computed by analyzer 298 multiple times. In another example, MC 396 may request an estimated stress level associated with SUT 112 at or near the end of a test session, e.g., as a final or end score.

For example, as depicted in FIG. 5, MC 396 may be configured for polling (e.g., requesting from) SUT 112 (or a related entity) for SUT performance data (e.g., SUT performance or health metrics) and for obtaining monitored traffic data (e.g., copied packets, metrics related to total traffic rates or percentage of fuzzed monitored traffic, etc.) during the course of a monitoring session (e.g., at different points in time). In this example, MC 396 may query analyzer 298 (or a trained ML model thereof) for estimated or inferred stress state values using recently obtained data, e.g., as conditions change.

In another example, MA 398 or analyzer 298 may be configured for performing stress state checks at period or predetermined intervals, e.g., every 60 seconds, when a monitored load reaches a certain threshold values, at a particular time in the day, etc. In this example, MA 398 or analyzer 298 may be capable of requesting or accessing relevant information from appropriate sources, e.g., data stores, SUT 112, MA 398, or various agents or devices. Continuing with this example, MA 398 or analyzer 298 may input the data or a version thereof (e.g., one or more binary vectors representing various features) into an appropriate trained ML model (e.g., software executing on one or more processors) to obtain a predicted or estimated stress state value based on the input.

In some embodiments, e.g., prior to a test session, MC 396 or another entity may select an appropriate trained ML model from an ML model data store (e.g., located in an accessible memory or storage device). For example, using a monitoring system operator's preferences or settings, MC 396 may identify a trained ML model that most closely matches the environment or SUT 112 being monitored.

Referring to FIG. 5, at 501, MC 396 may send or apply a monitoring profile at or on MA 398. For example, MA 398 may be a smart tap or other entity capable of using a receive monitoring profile to monitor particular packets or types of packets.

At 502, MC 396 may instruct MA 398 and/or other entities to start monitoring. For example, MC 396 may send a start command to MA 398 via a control plane or a management protocol.

At 503, at some point during a monitoring session, MC 396 may request and receive SUT performance data from SUT 112 or a related entity (e.g., a SUT-based reporting agent). For example, using a SUT supported API, MC 396 may request current (e.g., most recent) SUT metrics or SUT state information from SUT 112 and SUT 112 may respond to the request with the requested information.

At 504, MC 396 may request and receive monitored traffic data from MA 398 or a related entity (e.g., a MA-based reporting agent). For example, using a supported API, MC 396 may request current (e.g., most recent) traffic metrics or packet copies from MA 398 and MA 398 may respond to the request with the requested information.

At 505, MC 396 may request an estimated or inferred stress state value associated with SUT 112 (e.g., indicating how close to failing or crashing SUT 112 is) from analyzer 298 or a related trained ML model. For example, using a supported API, MC 396 may provide collected SUT performance data and traffic data to analyzer 298 and a trained ML model associated with analyzer 298 may use at least some of this data to generate or compute a stress state value associated with SUT 112.

At 506, analyzer 298 or a related entity (e.g., a trained ML model thereof) may use input (e.g., SUT performance data and monitored traffic data) obtained from MC 396 or other entities to generate a current estimated or inferred stress state value associated with SUT 112. For example, analyzer 298 may receive data from TC 104 or another entity and generate, using the data, one or more vectors for a trained ML model and the trained ML model may output a stress state value (e.g., a stress level) using the one or more generated vectors and/or other data as input.

At 507, analyzer 298 or a related entity may provide the estimated or inferred stress state value associated with SUT 112 (e.g., indicating how close to failing or crashing SUT 112 is) to MC 396. For example, after determining a stress state value associated with SUT 112, analyzer 298 may provide the stress state value to MC 396, e.g., via a supported API, protocol, or delivery mechanism.

At 508, at a later point in the monitoring session, MC 396 may request and receive SUT performance data from SUT 112 or a related entity (e.g., a SUT-based reporting agent). For example, using a SUT supported API, MC 396 may request current (e.g., most recent) SUT metrics or SUT state information from SUT 112 and SUT 112 may respond to the request with the requested information.

At 509, MC 396 may request and receive monitored traffic data from MA 398 or a related entity (e.g., a MA-based reporting agent). For example, using a supported API, MC 396 may request current (e.g., most recent) traffic metrics or packet copies from MA 398 and MA 398 may respond to the request with the requested information.

At 510, MC 396 may request an estimated or inferred stress state value associated with SUT 112 (e.g., indicating how close to failing or crashing SUT 112 is) from analyzer 298 or a related trained ML model. For example, using a supported API, MC 396 may provide collected SUT performance data and traffic data to analyzer 298 and a trained ML model associated with analyzer 298 may use at least some of this data to generate or compute a stress state value associated with SUT 112.

At 511, analyzer 298 or a related entity (e.g., a trained ML model thereof) may use input (e.g., SUT performance data and monitored traffic data) obtained from MC 396 or other entities to generate a current estimated or inferred stress state value associated with SUT 112. For example, analyzer 298 may receive data from TC 104 or another entity and generate, using the data, one or more vectors for a trained ML model and the trained ML model may output a stress state value (e.g., a stress level) using the one or more generated vectors and/or other data as input.

At 512, analyzer 298 or a related entity may provide the estimated or inferred stress state value associated with SUT 112 (e.g., indicating how close to failing or crashing SUT 112 is) to MC 396. For example, after determining a stress state value associated with SUT 112, analyzer 298 may provide the stress state value to MC 396, e.g., via a supported API, protocol, or delivery mechanism.

It will be appreciated that FIG. 5 is for illustrative purposes and that various actions and functionality described above in relation to FIG. 5 may be changed, altered, added, or removed. For example, various functionality in analyzer 298 and MC 396 may be combined into a single entity. In another example, MA 398 may include analyzer 298, a trained ML model, or related functionality. In some examples, analyzer 298 may be configured to periodically or aperiodically obtain traffic data and SUT performance data directly from source(s) and generate a new stress state value using the recently obtained data.

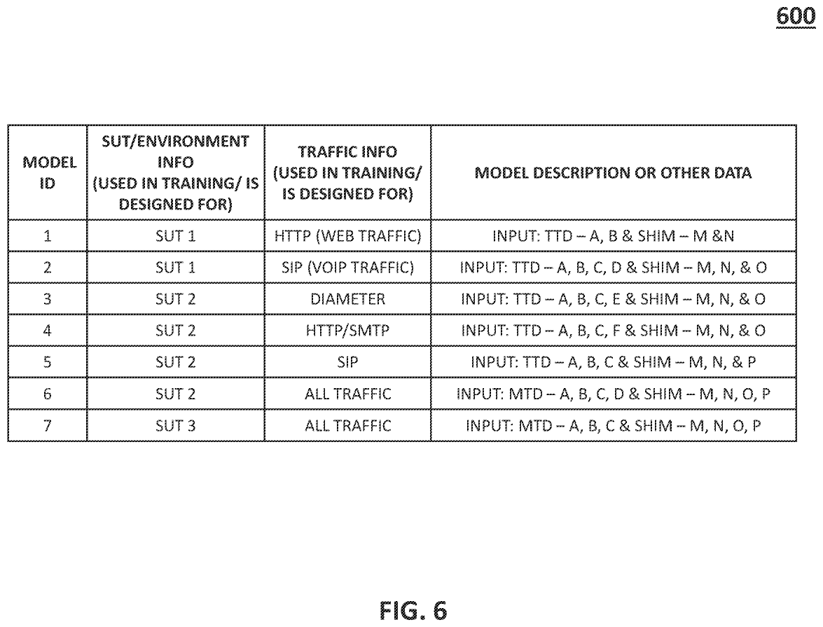

FIG. 6 is a diagram illustrating example model metadata 600 usable for selecting a trained ML model. In some embodiments, metadata 600 may include any suitable information for describing aspects of various trained ML models and/or for selecting a relevant training ML model, e.g., depending on expected usage and/or environment. For example, metadata 600 may include a model identifier, SUT and traffic data used in training the related model, and a description or other data, e.g., information indicating inputs used by the related model. In some examples, metadata 600 may include information indicating what output is generated by a given ML model and/or what ML architecture (e.g., RNN, CNN, FNN, etc.) is utilized by the given ML model.

In some embodiments, a human operator or a management entity may utilize metadata 600 to select appropriate trained ML models, e.g., for monitoring stress levels of a system or device, e.g., SUT 112. For example, a human may attempt to search for an appropriate trained ML model by identifying the ML model that matches a number of desired characteristics, e.g., a particular SUT and/or environment used in training, a particular type of traffic used in training, and particular inputs that the model uses. In another example, a management entity may use predetermined selection rules for selecting an appropriate ML model. In this example, the predetermined rules may indicate a highest priority attribute or criterium used for matching and may also indicate decreasingly preferred attributes or criteria when necessary.

In some embodiments, metadata 600 or portions or variations thereof may be accessed and/or stored by test system 102, monitoring system 394, and/or other entities (e.g., analyzer 298, TC 104, MC 396, etc.) using one or more data structures or storage devices. For example, data storage 110 or another entity may include a local data store comprising metadata 600 or a portion thereof.

Referring to FIG. 6, metadata 600 may be depicted using a table representing various types of data associated with a trained ML model for generating a stress state value. For example, each table row depicted in FIG. 6 may represent a model identifier (ID) indicating a particular ML model, SUT and/or environment information used in training the ML model (or for which the ML model was designed), traffic information used in training the ML model (or for which the ML model was designed), and a model description or other information for describing the ML model or one or more aspects thereof.

A model ID may include any suitable information for identifying a trained ML model for generating a stress state value. For example, a model ID may be a value (e.g., an alphanumeric value, an integer, or a letter) that uniquely identifies a trained ML model. In this example, the model ID may act as a lookup value or provide a way to download or access a particular trained ML model from a data store (e.g., data storage 110) for use in a testing or monitoring environment.

SUT and/or environment information associated with a particular model ID may indicate which SUT or environment was used in training the corresponding model or may indicate SUT and/or environment attributes for which the corresponding model was designed or is suitable. For example, when training an ML model, fuzz test sessions may be performed involving a particular configuration of SUT 112 or a test environment with particular characteristics. As such, in this example, the trained ML model may provide more accurate stress state values when the usage environment/configuration matches or is similar to the training environment/configuration.

Traffic information associated with a particular model ID may indicate which traffic or traffic profiles (e.g., types or mixes of traffic) was used in training the corresponding model or may indicate traffic attributes (e.g., protocol types, fuzzing effects, etc.) for which the corresponding model was designed or is suitable. For example, when training an ML model, fuzz test sessions may be performed involving one or more traffic profiles and fuzzing profiles. As such, in this example, the trained ML model may provide more accurate stress state values when the traffic in the usage environment/configuration matches or is similar to the traffic used in the training.

Model description or other data associated with a particular model ID may include a text description of input, output, or other information. For example, in addition to providing to a user information about what inputs are used in generating an input vector for a particular trained ML model, additional information may also indicate what output is generated or in what format output is provided. In some embodiments, model description or other data may also indicate the date a trained ML model was created or modified or what type of ML architecture is the model utilizing, e.g., an RNN or an FNN.

It will be appreciated that metadata 600 in FIG. 6 is for illustrative purposes and that different and/or additional information may also be stored or maintained. Further, it will be appreciated that metadata 600 or related data may be stored in various data structures, memories, or computer readable media and that metadata 600 or related data may be stored in one or more locations.

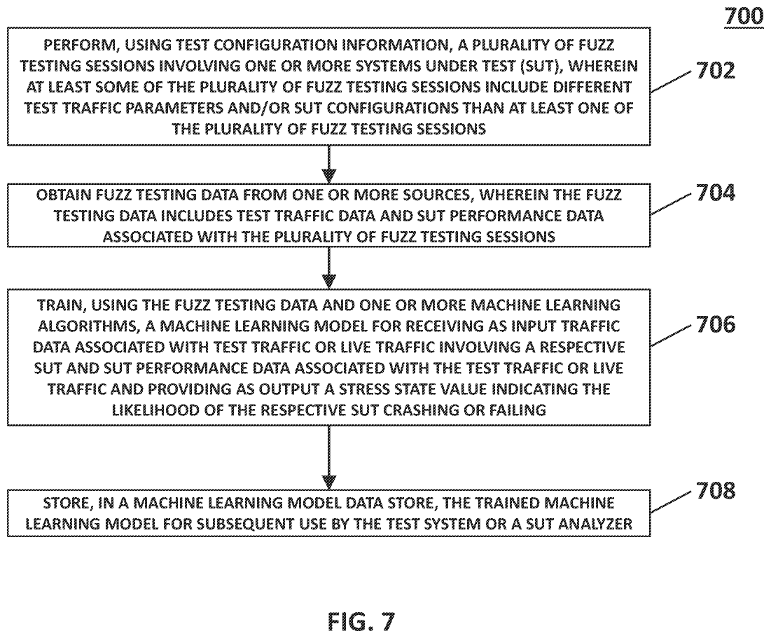

FIG. 7 is a block diagram illustrating an example process 700 for training an ML model using fuzz test data. In some embodiments, example process 700 may include steps 702, 704, 706, and/or 708. In some embodiments, process 700, or portions thereof, may be performed by test system 102, TC 104, and/or another node or module.

Referring to FIG. 7, in step 702, a plurality of fuzz testing sessions involving one or more systems under test (SUT) are performed using test configuration information. In some embodiments, at least some fuzz testing sessions may include different test traffic parameters and/or SUT configurations than at least one of the plurality of fuzz testing sessions.

In step 704, fuzz test data may be obtained from one or more sources. In some embodiments, fuzz test data may include test traffic data and SUT performance data associated with the plurality of fuzz testing sessions.

In step 706, an ML model may be trained using the fuzz test data and one or more ML algorithms. In some embodiments, a trained ML model may be trained or configured for receiving as input traffic data associated with test traffic or live traffic involving a respective SUT and SUT performance data associated with the test traffic or live traffic and providing as output a stress state value indicating the likelihood of the respective SUT crashing or failing.

In some embodiments, one or more ML algorithms (e.g., used in generating or training the ML model) may include an ANN, an FNN, an RNN, or a CNN.

In some embodiments, fuzz test data used in training may include test results. For example, test results used in training an ML model may include a final binary result indicating pass or failure for a respective SUT at the end of a respective fuzz testing session and a final operator-provided value or metric on a predetermined scale indicating a likelihood or nearness to failure for a respective SUT at the end of a respective fuzz testing session.

In some embodiments, fuzz test data used in training may include values or metrics on a predetermined scale indicating a likelihood or neamess to failure for a respective SUT at various points in time during a respective fuzz test session.

In some embodiments, fuzz test data used in training may be correlated using timestamps. For example, test system 102 or monitoring system 394 may utilize a time synchronization mechanism (e.g., a leader/follower clock architecture) such that test data from multiple sources (e.g., SUT 112 and TA 296) can be correlated using reliable and accurate timestamps.

In some embodiments, training an ML model may utilize an unsupervised learning technique (e.g., where the training dataset does not include labeled outcomes or explicit ground truths) and/or a supervised learning technique.

In step 708, the trained ML model may be stored in an ML model data store. In some embodiments, an ML model data store or trained ML models therein may be available for subsequent use by the test system or a SUT analyzer, e.g., analyzer 298, monitoring system 394, etc.

In some embodiments, an SUT analyzer (e.g., analyzer 298 or monitoring system 394) may be configured for receiving, via test system 102 or the ML model data store (e.g., data storage 110), a trained ML model; receiving traffic data and SUT performance data associated with network traffic involving SUT 112; generating, using the traffic data and the SUT performance data as input to the trained ML model, a stress state value associated with SUT 112; and providing the stress state value to a display, a user, or another entity.

In some embodiments, test system 102 may be configured for receiving traffic data and SUT performance data associated with an on-going or completed first fuzz testing session involving SUT 112; generating, using the traffic data and the SUT performance data as input to a trained machine learning model, a stress state value associated with SUT 112; and providing the stress state value to a display, a user, or another entity.

In some embodiments, traffic data used as input to a trained ML model may include copies of network traffic, log data, or traffic metrics and at least some of the traffic data may be obtained from test system 102, FTM 108, TG 106, MA 398 (e.g., a network probe or a network tap), one or more data repositories (e.g., data storage 110), or SUT 112.

In some embodiments, SUT performance data used as input to a trained ML model may include performance or health statistics or metrics, SUT state information, error information, or failure information and at least some of the SUT performance data may be obtained from test system 102, the one or more data repositories, or the SUT.

It will be appreciated that process 700 is for illustrative purposes and that different and/or additional actions may be used. It will also be appreciated that various actions described herein may occur in a different order or sequence.

It should be noted that test system 102, ML model generator 300, analyzer 298, monitoring system 394, and/or various modules, nodes, or functionality described herein may constitute a special purpose computing platform, device, or system. For example, test system 102, ML model generator 300, analyzer 298, or monitoring system 394 may be a network appliance or node configured to perform various aspects described herein. Further, test system 102, ML model generator 300, analyzer 298, monitoring system 394, or functionality described herein can improve the technological field of network testing by providing various techniques, systems, methods, or mechanisms for estimating, predicting, assessing, inferring, or determining a stress level (e.g., a stress state value) on SUT 112 or another entity (e.g., a system being monitored) using an ML model trained using fuzz test data (e.g., from prior fuzz test sessions involving SUT 112 or a similar (e.g., comparable) system or device.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for training a machine learning model for indicating a stress state value associated with a system under test (SUT), the method comprising:
at a test system:
performing, using test configuration information, a plurality of fuzz testing sessions involving one or more systems under test (SUT), wherein at least some of the plurality of fuzz testing sessions include different test traffic parameters and/or SUT configurations than at least one of the plurality of fuzz testing sessions;
obtaining fuzz test data from one or more sources, wherein the fuzz test data includes test traffic data and SUT performance data associated with the plurality of fuzz testing sessions;
training, using the fuzz test data and one or more machine learning algorithms, a machine learning model for receiving as input traffic data associated with test traffic or live traffic involving a respective SUT and SUT performance data associated with the test traffic or live traffic and providing as output a stress state value indicating the likelihood of the respective SUT crashing or failing; and
storing, in a machine learning model data store, the trained machine learning model for subsequent use by the test system or a SUT analyzer.

2. The method of claim 1 wherein the one or more machine learning algorithms includes an artificial neural network, a feedforward neural network, a recurrent neural network, or a convolutional neural network.

3. The method of claim 1 wherein the fuzz test data used in training includes test results, wherein the test results include a final binary result indicating pass or failure for a respective SUT at the end of a respective fuzz testing session; and a final operator-provided value or metric on a predetermined scale indicating a likelihood or nearness to failure for a respective SUT at the end of a respective fuzz testing session.

4. The method of claim 1 wherein the fuzz test data used in training includes values or metrics on a predetermined scale indicating a likelihood or nearness to failure for a respective SUT at various points in time during a respective fuzz test session.

5. The method of claim 1 wherein the fuzz test data used in training is correlated using timestamps.

6. The method of claim 1 wherein the training of the machine learning model utilizes an unsupervised learning technique and/or a supervised learning technique.

7. The method of claim 1 comprising:
at the SUT analyzer:
receiving, via the test system or the machine learning model data store, the trained machine learning model;
receiving traffic data and SUT performance data associated with network traffic involving a first SUT;
generating, using the traffic data and the SUT performance data as input to the trained machine learning model, a stress state value associated with the first SUT; and
providing the stress state value to a display, a user, or another entity.

8. The method of claim 1 comprising:
at the test system:
receiving traffic data and SUT performance data associated with an on-going or completed first fuzz testing session involving a first SUT;
generating, using the traffic data and the SUT performance data as input to the trained machine learning model, a stress state value associated with the first SUT; and
providing the stress state value to a display, a user, or another entity.

9. The method of claim 8 wherein the traffic data includes copies of network traffic, log data, or traffic metrics and at least some of the traffic data is obtained from the test system, a fuzz testing module, a traffic generator, a monitoring agent, a network probe, a network tap, one or more data repositories, or the SUT; and
wherein the SUT performance data includes performance or health statistics or metrics, SUT state information, error information, or failure information and at least some of the SUT performance data is obtained from the test system, the one or more data repositories, or the SUT.

10. A system for training a machine learning model using fuzz test data, the system comprising:
a memory;
at least one processor; and
a test system implemented using the memory and the at least one processor, the test system configured for:
performing, using test configuration information, a plurality of fuzz testing sessions involving one or more systems under test (SUT), wherein at least some of the plurality of fuzz testing sessions include different test traffic parameters and/or SUT configurations than at least one of the plurality of fuzz testing sessions;
obtaining fuzz test data from one or more sources, wherein the fuzz test data includes test traffic data and SUT performance data associated with the plurality of fuzz testing sessions;
training, using the fuzz test data and one or more machine learning algorithms, a machine learning model for receiving as input traffic data associated with test traffic or live traffic involving a respective SUT and SUT performance data associated with the test traffic or live traffic and providing as output a stress state value indicating the likelihood of the respective SUT crashing or failing; and
storing, in a machine learning model data store, the trained machine learning model for subsequent use by the test system or a SUT analyzer.

11. The system of claim 10 wherein the one or more machine learning algorithms includes an artificial neural network, a feedforward neural network, a recurrent neural network, or a convolutional neural network.

12. The system of claim 10 wherein the fuzz test data used in training includes test results, wherein the test results include a final binary result indicating pass or failure for a respective SUT at the end of a respective fuzz testing session; and a final operator-provided value or metric on a predetermined scale indicating a likelihood or nearness to failure for a respective SUT at the end of a respective fuzz testing session.

13. The system of claim 10 wherein the fuzz test data used in training includes values or metrics on a predetermined scale indicating a likelihood or nearness to failure for a respective SUT at various points in time during a respective fuzz test session.

14. The system of claim 10 wherein the fuzz test data used in training is correlated using timestamps.

15. The system of claim 10 wherein the training of the machine learning model utilizes an unsupervised learning technique and/or a supervised learning technique.

16. The system of claim 10 wherein the SUT analyzer configured for:
receiving, via the test system or the machine learning model data store, the trained machine learning model;
receiving traffic data and SUT performance data associated with network traffic involving a first SUT;
generating, using the traffic data and the SUT performance data as input to the trained machine learning model, a stress state value associated with the first SUT; and
providing the stress state value to a display, a user, or another entity.

17. The system of claim 10 wherein the test system is configured for:
receiving traffic data and SUT performance data associated with an on-going or completed first fuzz testing session involving a first SUT;
generating, using the traffic data and the SUT performance data as input to the trained machine learning model, a stress state value associated with the first SUT; and
providing the stress state value to a display, a user, or another entity.

18. The system of claim 17 wherein the traffic data includes copies of network traffic, log data, or traffic metrics and at least some of the traffic data is obtained from the test system, a fuzz testing module, a traffic generator, a monitoring agent, a network probe, a network tap, one or more data repositories, or the SUT; and
wherein the SUT performance data includes performance or health statistics or metrics, SUT state information, error information, or failure information and at least some of the SUT performance data is obtained from the test system, the one or more data repositories, or the SUT.

19. A non-transitory computer readable medium comprising computer executable instructions embodied in the non-transitory computer readable medium that when executed by a processor of a computer perform steps comprising:
at a test system:
performing, using test configuration information, a plurality of fuzz testing sessions involving one or more systems under test (SUT), wherein at least some of the plurality of fuzz testing sessions include different test traffic parameters and/or SUT configurations than at least one of the plurality of fuzz testing sessions;
obtaining fuzz test data from one or more sources, wherein the fuzz test data includes test traffic data and SUT performance data associated with the plurality of fuzz testing sessions;
training, using the fuzz test data and one or more machine learning algorithms, a machine learning model for receiving as input traffic data associated with test traffic or live traffic involving a respective SUT and SUT performance data associated with the test traffic or live traffic and providing as output a stress state value indicating the likelihood of the respective SUT crashing or failing; and
storing, in a machine learning model data store, the trained machine learning model for subsequent use by the test system, a network analyzer, or a device.

20. The non-transitory computer readable medium of claim 19 wherein the one or more machine learning algorithms includes an artificial neural network, a feedforward neural network, a recurrent neural network, or a convolutional neural network.
